(19) United States
(12) Patent Application Publication
(10) Pub. No.: US 2005/0222962 A1
(43) Pub. Date: Oct. 6, 2005

(54) Method, system and computer program for a shared access multi-use computer terminal accessible to operators and customers

(76) Inventor: John N. Buckle, Bradford (CA)

Correspondence Address: MILLER THOMPSON, LLP, 20 QUEEN STREET WEST, SUITE 2500, TORONTO, ON, M5H 3S1, CA

(21) Appl. No.: 11/094,266

(22) Filed: Mar. 31, 2005

(30) Foreign Application Priority Data
Mar. 31, 2004 (CA) 2,462,623

(51) Int. Cl. G06F 17/60

(52) U.S. Cl. 705/67

(57) ABSTRACT

The invention provides a method for providing a plurality of computer terminals where access to the computer terminals is shared between operators and customers. Revenue generating activities are directed to the customers thereby subsidizing or paying for the cost of the computer terminals. Another aspect of the invention is a computer system including the computer terminal and a server computer configured to provide and application service provider that provides access to a series of revenue generating resources to customers, and to a series of applications related to operational activities to the operator. The present invention also provides a client application resident on the computer terminals and a server application resident on the server computer.

### FIELD OF THE INVENTION

This invention relates to business methods that include a revenue model for providing a shared access to a multi-use computer terminal linked to a computer network accessible to operators and customers. This invention also related to a system and computer program for providing an operational/entertainment computer terminal linked to a network that is accessible to operators and customers.

### BACKGROUND OF THE INVENTION

Electronic information systems are known that provide distribution of medical information and patient services, where the patient services include entertainment services. For example, U.S. Pat. No. 5,867,821 issued to Paxton Development Inc. discloses a system comprising a plurality of nursing stations and one or more are electronically associated with each of the nursing stations. The master library stores data preferably in digital compressed form selected from one or more of the following: (a) patient/medical staff health record information, (b) clinical data including X-Ray, MRI and video images, (c) patient laboratory data to support medical diagnoses and investigations, (d) educational/training information in video or textual format for the training of medical personnel and patient requirements, (e) pharmaceutical databases, (f) entertainment audio/video data, (g) monitored video of critical areas including operating rooms and psychiatric wards, (h) general security video monitoring data, and (i) management information data including accounting, billing and inventory control/ordering services. As well, the master library is preferably provided with means to receive and store, in digitally compressed form, data from one or more of the following: (a) physicians' offices; (b) clinics and laboratories; (c) video entertainment libraries; (d) electronic medical libraries; (e) hospital security, patient and operating room monitoring information; and (f) patients' residences.

The disadvantage of such prior art systems is that they generally necessitate the purchase of such systems by the hospital. Where there are heavy demands on health care monetary resources, the purchase of such systems that are beneficial to health care providers and patients alike can be prohibitive. What is needed is a business model that enables the assumption of the cost of acquiring and maintaining the system by parties other than the hospital (“operator”) but rather by a third party who offsets the cost of the acquisition/maintenance by generating revenue from activities related to activities of patients (“customers”) in relation to the system. What is needed is a system and computer program that enables this shared access by the operator and the customers in an efficient and cost effective manner while addressing issues around privacy, and security and confidentiality of information.

### BRIEF DESCRIPTION OF THE DRAWINGS

A detailed description of the preferred embodiment(s) is(are) provided herein below by way of example only and with reference to the following drawings, in which:

FIG. 1a is a perspective view of a representative embodiment of the terminal of the present invention.

FIG. 1b is a resource diagram illustrating the resources of the terminal of the present invention.

FIG. 2 is a system resource diagram illustrating the resources of the present invention.

FIG. 3 is a program resource diagram illustrating the principal resources of the server application of the present invention.

FIG. 4 is a program resource diagram illustrating the principal resources of the client application of the present invention.

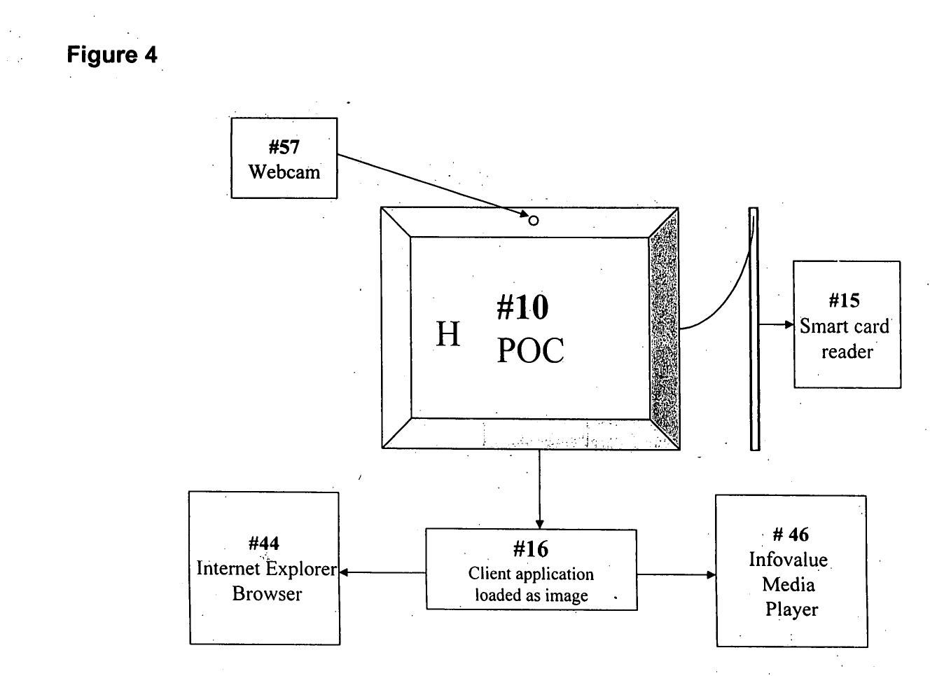

In the drawings, preferred embodiments of the invention are illustrated by way of example. It is to be expressly understood that the description and drawings are only for the purpose of illustration and as an aid to understanding, and are not intended as a definition of the limits of the invention.

### SUMMARY OF THE INVENTION

In one aspect of the present invention, a point of care system is provided that includes at least one computer terminal and a server computer linked to the at least one computer terminal. The server computer includes a server application, which is operable to provide on the server computer: an interface utility that is operable to link to one or more hospital systems, such hospital systems including one or more of a bed management system, a health record management system, and a clinical information system. The server application also includes a client service delivery facility, the client service delivery facility being operable to deliver services to the computer terminal, whether by operation of resources made available at the server computer or resources provided by other systems linked to the server computer, wherein the client service delivery facility is operable to manage the delivery of such services to the computer terminal. The computer terminal and the server computer are operable to co-operate to provide access at the at least one computer terminal: to the one or more hospital systems to authorized hospital personnel; and to the services of the client service delivery facility to authorized hospital clients. The computer terminal is further operable to be used by authorized hospital personnel in conjunction with one or more medical devices, or as a medical device.

The at least one computer terminal is medically certified. In particular, the technical specifications for the at least one computer terminal meets regulatory standards or best practices related to its use in conjunction with or as a medical device.

In another particular aspect of the present invention, the at least computer terminal is linked to a client application, and the client application includes: an access management facility that is operable to restrict access to the resources of the computer terminal to authorized users only, and to restrict access to specific resources of the computer terminal based on corresponding permissions defined for a particular authorized user; and a security facility that is operable to ensure that confidential or private data remains secure. The security facility is operable to prevent the computer terminal, or another device linked to the computer terminal, from making a copy of any confidential or private data accessed at the at least one computer terminal.

The client service delivery facility preferably includes a service management facility that is operable to manage access to services to clients, including sign-up of clients, management of client accounts, and client billing and payment.

The client service delivery facility preferably provides access to one or more of the following resources: a food management system enabling patients to order their meals subject to any restrictions determined based on the patient's profile; Internet access; Voice-Over-IP telephone services; and/or Entertainment services, including access to movies, music, television channels.

The server application includes a media delivery application, wherein the server computer is linked to a database, wherein the database stores a library of media content, or is linked to an external database including media content, and wherein the media delivery application is operable to provide access to such media content to the at least one computer terminal, as well as to audiovisual content obtained via the Internet or satellite feed.

A method is also provided whereby the provision of services to clients is used to subsidize the cost of providing the medically certified computer terminals at the bedside of the patients.

### DETAILED DESCRIPTION OF THE PREFERRED EMBODIMENTS

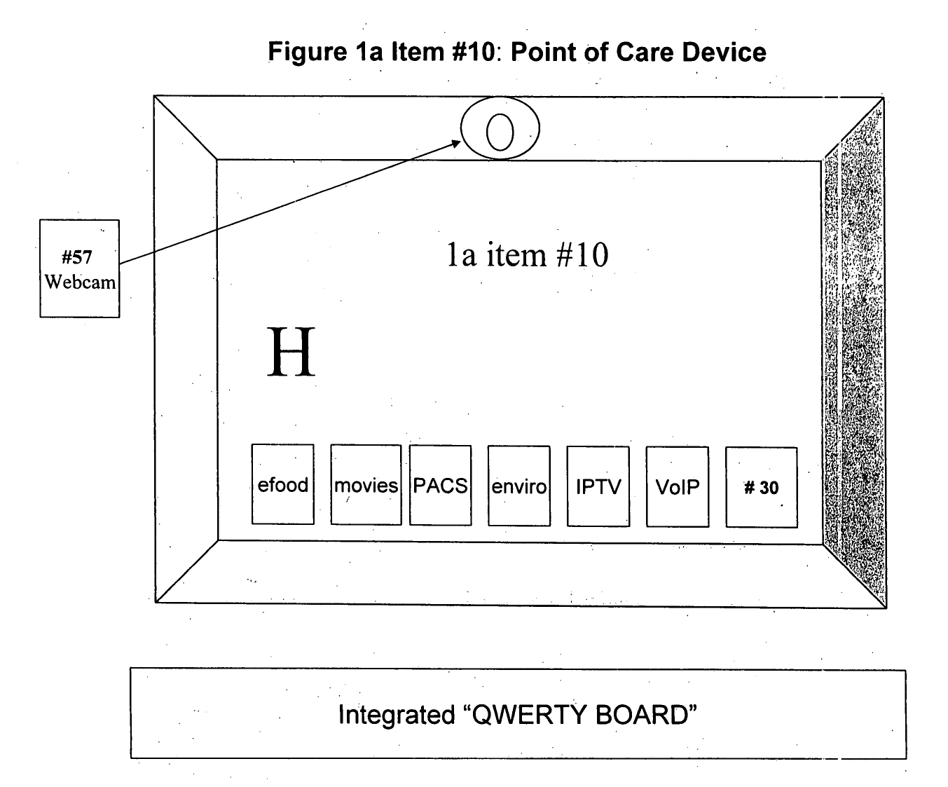

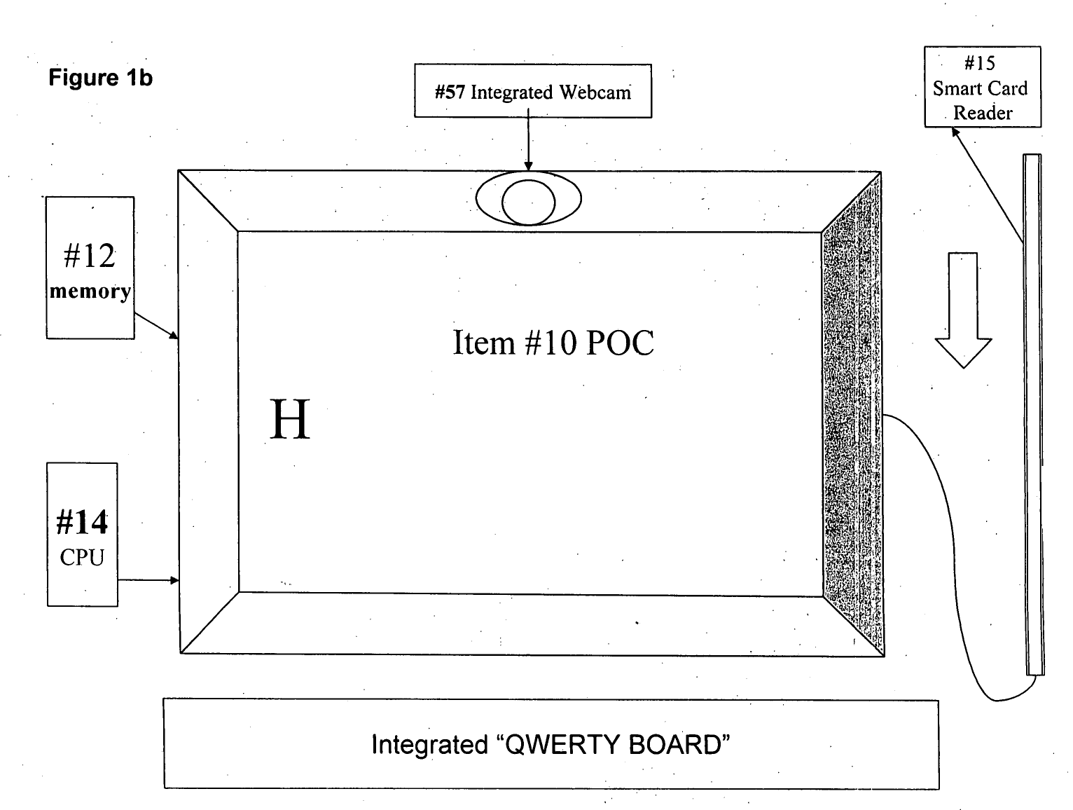

FIG. 1a illustrates in a representative embodiment thereof the computer terminal 10 of the present invention. The computer terminal, in one embodiment thereof, consists of a medically certified Point of Care (“POC”) computer terminal that is preferably provided at each bedside.

The computer terminal 10 of the present invention is configured, as particularized below, for accessing by one or more “operators” and also one or more “customers” (also referred to in some cases as “clients”). The present disclosure refers to “hospital” generally, however, it should be understood that the present invention also applies to any manner of health care organization including clinics, retirement homes and the like. The word “hospitals” as used in this disclosure should be taken to mean any such health care organizations. “Operators” in this disclosure refer to the operators or managers of a facility who us the computer terminal 10 of the present invention for the purposes of operating the facility (unless the context dictates otherwise). The “customers” are clients of the health care facility. In the context of implementation of the present invention in a hospital, for example, the operators are hospital staff such as nurses and doctors, and the customers are patients. In the context of a hotel, the operators are hotel staff, the customers are hotel guests.

The computer terminal 10 in one particular embodiment thereof consists of a flat panel resistive touch screen. This provides an easy to use input means including for individuals with physical challenges. The computer terminal 10 may also be linked to other common input devices including a keyboard and/or mouse.

In another aspect of a particular embodiment of the computer terminal 10, the terminal is medically certified, and accordingly the exterior shell of the computer terminal 10. Electronic products for medical use must be designed for safety, minimum interaction with other electronic devices, and for military-grade reliability. More specifically, they should preferably conform to the UL2601 standard in the United States/Canada and EN60601 standard (including both EN60601-1-1, EN60601-1-2) in Europe. The goal of these standards is to ensure that all medical electronic products provide a high level of safety for operators and patients. In one particular aspect of the computer terminal 10, the POC-153M/123M is a medical-certified panel computer with UL2601/EN60601 approval, and the low leakage current power supply enables the series to serve as an advantageous and secure point-of-care solution for patients and hospital practitioners.

To meet the requirements of a public environment, the POC-153M/123M complies with the IP 65/NEMA 4-protection standard. The watchdog timer and power management features make the system even more secure and stable. The on-board hardware monitoring feature provides automatic protection function, which prevents the CPU from being overheated.

As shown in FIG. 1b, the computer terminal 10 included a memory 12, CPU 14. The computer terminal 10 is linked to a known card swipe device 15.

Loaded on computer terminal 10 is a client application 16, as particularized below.

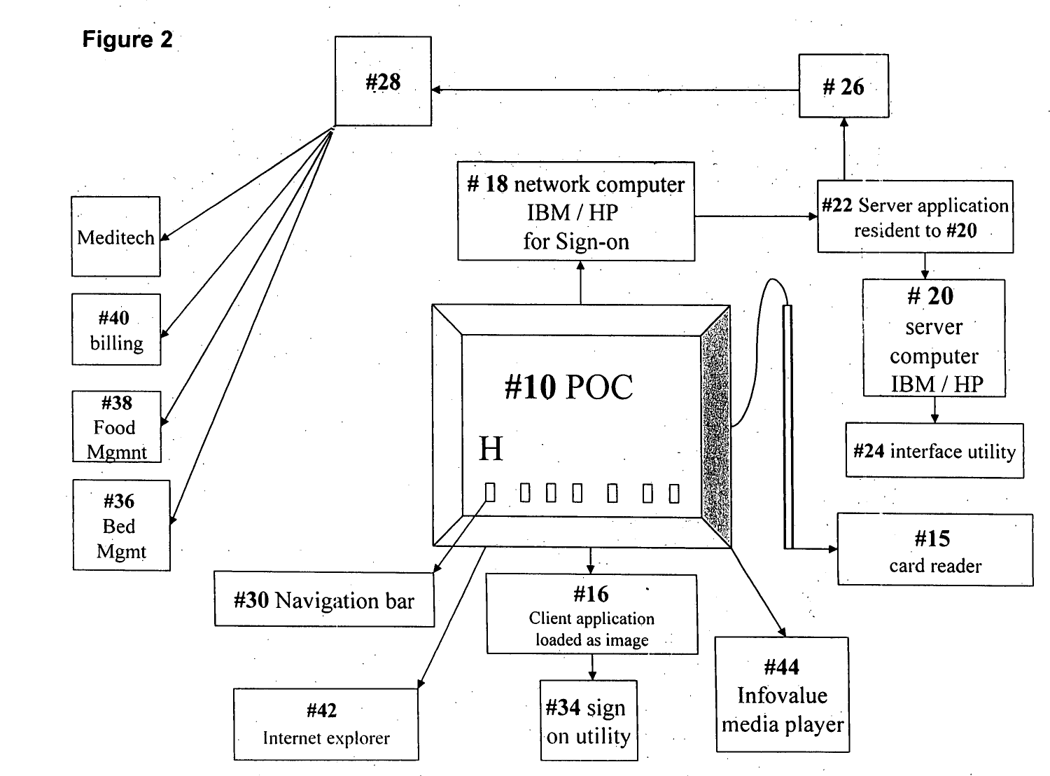

As shown in FIG. 2, the computer terminal 10 is connected to the network 18. The resources of the overall system of the present invention, which includes the computer terminal 10 and the network 18 are illustrated in FIG. 2. In one particular embodiment thereof, the system of the present invention enables the delivery at the computer terminal 10 of bedside technology solutions on an enterprise wide format via an Internet Protocol based communication system for hospitals with little or no requirement to utilize capital budget requirements to obtain the technology solutions.

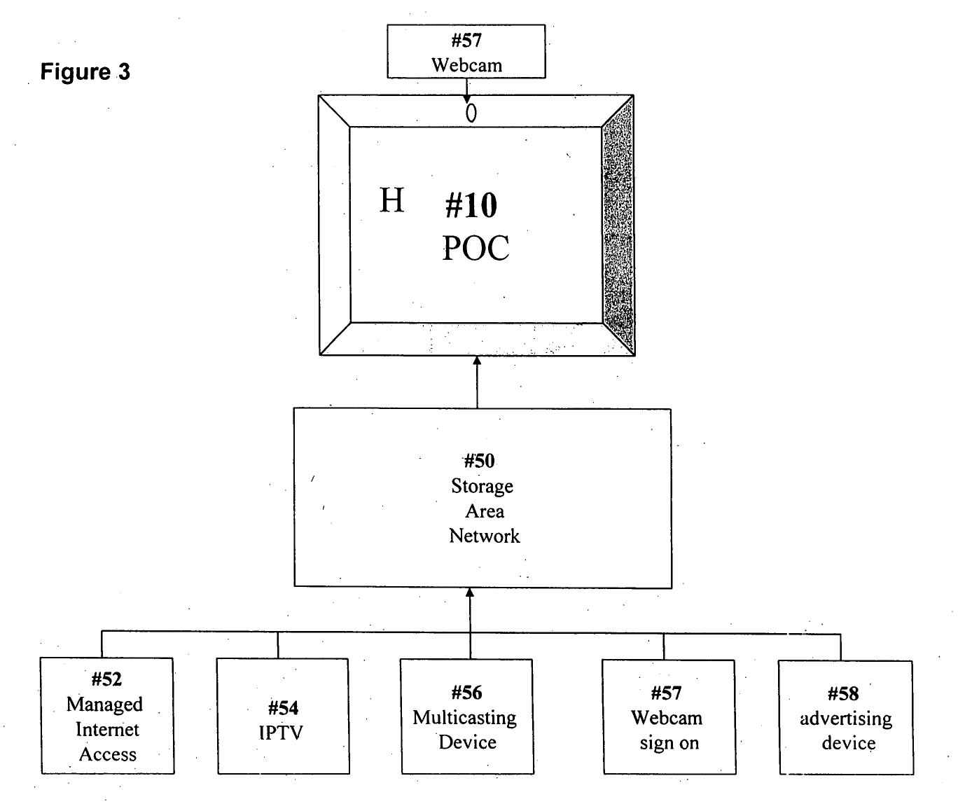

The network 18 includes a server computer 20, provided utilizing known hardware and software utilities. Linked to the server computer 20 is the server application 22, the resources of which are illustrated in FIG. 3. In one particular embodiment of the present invention, the system of the present invention operates on an Application Service Provider (ASP) model utilizing a known ASP media format.

In a particular embodiment of the present invention, the server computer 20 is controlled by the operator. In another embodiment of the present invention, the server computer 20 is controlled by a third party who provides the computer terminals 10.

The server application 22 includes an interface utility 24. The known interface utility 24 enables the server application 22 to interact with a series of operator systems 26 including applications and/or remote servers through a known communication facility 28. For example, in the context of a hospital, the interface utility enables the server application 22, and thereby the computer terminal 10 linked to the server application 22, to interface with hospital systems including but not limited to existing systems for bed management, health record management and so on. The interactions between such operator systems 26 and the computer terminal 10 are outlined in greater detail below.

For example, the interface facility 24 enables creation of an interface between the server computer 20 and existing clinical information systems sold by MEDITECH™ or SIEMENS™. One particular aspect of the present invention is that by deployment of the system described and in particular by means of extensive deployment of the computer terminal 10 at the bed side wider access to these existing systems by hospital staff is achieved. This promotes quality of care and patient satisfaction.

It also should be understood that the computer terminal 10 is provided with a series of peripheral ports (not shown) that enable the linkage of the computer terminal 10 to a plurality of medical devices including for example heart monitors, blood pressure monitors and so on. The computer terminal 10 can also be used to access various applications that support the use of such medical devices. In this way, based on the revenue model contemplated in this invention, the computing cost associated with using such medical devices to their full potential is reduced or absorbed by the operator of the system of the present invention. Another example of applications that are already on site at each hospital are diagnostic images such as Magnetic Resonance Imaging (MRI's), Cat Scan, and Ultrasounds all of which can be accessed through the computer terminal 10. A computer terminal that is operable and can be medically certified to work in conjunction with such medical devices or to access medical information (such as the MRI images and the like) can be very costly indeed. In this disclosure, the aforesaid use of a computer terminal is referred to as “use of the computer terminal in conjunction with one or more medical devices or as a medical device”. This is because typically a computer terminal operable to enable the viewing and interaction with medical information, such as an MRI image for example, is considered a “Medical Device” for regulatory purposes.

The client application 16 provides connectivity to the network 18, and thereby the resources of the server application 22. The client application 16 includes a security layer 24 or security facility. The function of the security layer 24 is to create maintain a series of security between private or confidential data retrieved from operator systems 26 and the entertainment content and public network connectivity of the computer terminal 10. In one particular embodiment of the security layer 24 data obtained from the operator system 26 such as medical records and the like can be displayed on the computer terminal 10 but no resident copy can be created to memory 12.

The client application 16 provides a navigation bar 30 that provides easy access to the different functions of the client application 16 whether accessible by an operator or a customer. The client application 16 is best understood as a portal device that provides access to a number of operator functionalities to operators and customer functionalities to customers. For example, the representative navigation bar 30 illustrated in FIG. 1a includes an “H” (for Hospital) icon 32 that points to operator systems 26 accessible via the computer terminal 10, including for hospital information systems. One aspect of client application 16 is that it provides an access management facility or sign-on utility 34 that restricts access to specific functions to authorized personnel only. By operation of the sign-on utility 34 a username and password is requested from operator staff (in this example a doctor or a nurse) before providing access to the hospital information systems at the computer terminal 10, by means of the interface provided by the interface facility 24.

The sign-on utility 34 also administers access to customers to the functions of the computer terminal 10 designed for them. In one particular embodiment of the present invention, the system of the present invention interfaces with a known bed management 36 system found in most hospitals. The interface is provided by the interface facility 24 in a manner that is known. Bed management system 36 manages the provision of beds to patients, and also works to track patients who have been admitted to a hospital, including their admission/discharge, current status within the hospital, current location within the hospital and so on. By operation of the bed management system 36, each patient is given a patient ID which is linked to their personal information including for example contact information, billing information and so on.

In one particular aspect of the present invention, a patient signs on to the computer terminal 10 providing his/her ID established by the bed management system 36. This allows the patient to continue on the same account even as s/he is moved from room to room in the hospital as may occur. In another particular embodiment of the present invention, the bed management system 36 relies on a patient ID swipe card. The computer terminal 10 in this case enables the patient to swipe their card in the card swipe 15 thereby identifying himself/herself to the sign-on utility 34. The client application 16 may require the patient to create an additional username and/or password to access the resources of the computer terminal 10.

This link between the bed management system 36 and the computer terminal 10 of the present invention allows the customer (e.g. patient) to rely on the desired functionality and any selected attributes including account data to follow them real time even in the case of a transfer from one floor to another, for example.

The client application 16 provides access to a number of different resources. Generally these resources are of two types. The first consists of access to applications related to the operation of a hospital, for example, but where patient input is required or desirable. In one particular embodiment of the present invention, the client application 16 provides access to a known food management system 38 that enables patients to place orders for food within a set of parameters defined by the hospital.

The food management system 38 is an application that allows patients to select their own meal and in one particular embodiment thereof incorporates intelligences required for monitoring caloric intake based/patient profile (e.g. low sugars for diabetics, low carbohydrates and high protein). The food menu is integrated with the patient's profile based on admissions to reduce errors. The food menu is available through a secured network interface again via the same medically certified flat panel with a timed trigger protocol allowing patients to self serve their meals via the touch screen application or utilizing a mouse device. Specifically, the food management system 38 cooperates with the computer terminal 10 to provide an alarm to one or more patients in advance of a deadline defined by the food management system 38 for providing food choices via the computer terminal 10.

The client application 16 also includes a billing system 40 that enables the system of the present invention to track all of the billable activities of the customer via the computer terminal 10. The billing system 40 interfaces with operator billing systems, if required, by operation of the interface facility 24. The billing system also manages credit card and debit card transactions by means of the card swipe 15, in a manner that is known. The billing system 40 cooperates with the computer terminal 10 to enable the customer to input credit card or debit card information in a manner that is known. Another aspect of the billing system 40 is that facilitates payment of cash for billable activities of the customer via the computer terminal 10. For example, in relation to deployment of the present invention in the context of a hospital and/or medical clinics, hospitals and/or medical clinics generally have a staff person who collects cash as payment for services, medical devices and the like. This staff person is usually paged when required to take cash in a cash transaction. In a particular aspect of the present invention, when a patient provides an input indicating that s/he wishes to pay cash for a billable activity on the computer terminal 10, billing system 40 which is interfaced with the paging system (not shown) by means of the interface facility 24 sends a request to the paging system to page the staff person. Accordingly, the present invention enables cash transactions for billable activities on the computer terminal 10.

The billing system 40 enables customer to select from a plurality of payment plans regarding billable activities on the computer terminal 10. For example, customers can “pay as they use”, or alternatively can select a fixed daily fee for one or more of the service options accessible via the computer terminal 10 and described below.

One aspect of the billing management system 40 is that it defines standard packages of media services (as described above) based on the “average length of stay” (“ALOS”) at the particular facility. The billing management system 40 also enables the definition of parameters of “credit” authorized before payment of the billable charges accrued to that point must be cleared by a customer. Generally speaking, however, it is when a customer (e.g. patient) is discharged from the hospital that a final transaction will be processed to obtain payment for any billable charges incurred by the customer in their use of the computer terminal 10.

In one particular embodiment of the present invention, the billing system 40 is provided using a known billing utility such as the commercially available billing application of MICROS FIDELIOS™.

The client application 16 also includes a media content delivery utility 42, as best shown in FIG. 1b. In one particular embodiment of the present invention, the media content delivery utility 42 consists of a known browser 44 and a known media player 46. The media content delivery utility 42 enables customers to obtain paid access to a suite of entertainment products as described below.

The server application 22, as shown in FIG. 3, also includes a media delivery application 48 as particularized below. As shown in FIG. 2, the server computer 20 is linked to a database 50. The database 50 is best understood as a “Storage Area Network” or “SAN”. The media delivery application 48 is linked to one or more sources of media content, including for example a video library stored to the database 50 or streamed audiovisual content obtained from the Internet or a satellite feed.

One particular aspect of the present invention, is that the database 50 in accordance of the present invention is configured to store content created by the operator, or for the hospital, including media content specific to a hospital, for example, such as broadcasts of information regarding surgeries, public service announcements, training implementation, or other service that require a storage area network. The media delivery application 48 also enables the customer, in this case the hospital, to author, administer and manage their own media content, in a manner that is known. In one particular aspect of the method of the present invention, the operator of the system described may levy a monthly fee per gigabit space requirements as an increased amount of space is required by the hospital on the database 50.

In addition, the database 50 is configured to store additional media content such as on demand lifestyle change videos via the SAN. These videos can be provided at no charge to any patient and can be viewed anywhere in the hospital environment as well as having a dedicated portal access from either a hospital's website or a web site associated with the operator of the system of the present invention. Another specific application consists of providing discharge videos to patients using the computer terminal 10 specific to the procedure undergone by the patient.

The server application 22 also includes an Internet access utility 52 that provides managed Internet access in a manner that is known.

Internet Protocol Television (IPTV)

One aspect of the media delivery application 48 is a known Internet Protocol television facility 54 that enables Internet Protocol Television (“IPTV”) viewing at the computer terminal 10. This is facilitated in a manner that is known. In one particular implementation of the invention, the IPTV media format is received as an analogue signal from Rogers Cable, Shaw Cable, Cogeco Cable, Bell Expressvu, Aurora Cable and encoded into an Internet protocol address allowing the operator of the system to serve multiple locations via a centrally located multicasting device 56 to each hospital preferably via a dedicated gigabit fiber connection (not shown). One aspect of the method of the present invention, is that bases on the network architecture illustrated in FIG. 2, the costs associated with providing IPTV is distributed across a plurality of operators thereby providing the benefits of significant economies of scale.

Internet Access

In one particular implementation of the present invention, the Internet access utility 52 provides Internet access at the computer terminal 10 by in an on demand format from a single source provider. Patients will have access to the Internet using the browser 44 with preconfigured URL's for popular sites such as web mail portals such as (Rogers.com, Sympatico.ca, Shaw.com), banking institutions, internet game sites (NTN) and any other sites that hospitals request. This access is provided by means of payment via the billing management system 40 described above.

Webcam Access

In another particular aspect of the invention, the computer terminal 10 is also linked to a known web cam device 56, as illustrated in FIG. 1. By operation of the web cam device 56, patients have the ability to access an on demand web cam integrated into the flat panel of the computer terminal 10. The web cam, in cooperation with the Internet access available at the computer terminal 10, enables customers to send photos from their bed, send archived messages, chat live with anyone who has a web cam, all via the Internet.

Digital Music Channels

Patients have the ability to select from a multitude of digital music channels that are available from a coaxial cable feed. Streamed digital music channels can be provided via the Internet connection of the computer terminal 10 illustrated in FIG. 1b. For example, one such online digital content provider is www.galaxy.ca. The operator of the system of the present invention will provide a plurality of pre-selected music channels for patients to enjoy. It should also be understood that the present invention also contemplates using the computer terminal 10 to download music from other sources.

Pay Per View Movies (PPVM)

The operator of the system of the present invention will store movies to a library provided on the database 50. The movies can be obtained in VHS or DVD format and used to create an electronic file based on necessary consent from movie distributors. The library can be stored to the database 50 located at a particular operator's web site or at a remote location associated with the operator of the system, as the case may be. The media content delivery utility 42 cooperates with the database 50 to provide a digital distribution centre that enables customers (including patients) to access on demand any current movie in the then available catalogue.

Voice Over Internet Protocol (VoIP)

Yet another aspect of the computer terminal 10 is that it is configured to provide the infrastructure to provide LAN VoIP requirements. In one particular implementation of the present invention (not shown in FIG. 1a), a VoIP phone is integrated into the computer terminal 10. The VoIP phone leverages the Internet connectivity already provided to the computer terminal 10.

Revenue Model

Another aspect of the present invention is a method of providing access at a plurality of locations to computer terminals accessible to operators and customers, whereby revenue generation directed at the customers subsidizes or covers the access of the operators to the computer terminals.

The cost of providing computer terminals 10 that are medically certified, and are of the size that is readily provided at a bed side, and that have hardware components of the quality that provides desirable viewing of x-ray images for example, can be quite significant. Furthermore, the cost of providing a system connected to the computer terminals 10 that provides integrated access to a plurality of operator system 26 and that includes an SAN for education content for example is also quite significant.

In accordance with the method of the present invention, access to the system and the computer terminal 10 is provided at little or no cost to the operator, e.g. the hospital. In addition, the hospital is provided access to applications bundled with the computer terminal 10, including for example the food management system 38.

The cost of the foregoing is subsidized or paid for, also as stated earlier, by revenue generation activities related to the customer, e.g. patients in the case of the hospital. This is accomplished by charging patients for the billable activities referred to above.

Another significant source of revenue is advertising.

Another aspect of the server application 22 is the advertising utility 58 shown in FIG. 3. The advertising utility 58 is a known software application that enables the storage of advertising content to the database 50 and the delivery of advertising content to the computer terminal 10. One aspect of the advertising utility 58 is that it enables target delivery of advertising content based on control data defined by reference to various attributes of target customers including age, their reason for admission to a hospital or medical clinic, the ward they are located in, and so on.

Other advertising revenue can be generated by means of “sponsorship” of navigation pages, web pages, or other media content (including for example sponsorship of particular videos) displayed on the flat panel of the computer terminal 10 or the various components of the computer terminal 10.

For example, logos and marketing messages of consumer packaged good companies focussed are displayed on content shown by the flat panel. By operation of the advertising utility 58 (or selective application of logos to the body of the computer terminal 10), computer terminals 10 situated on maternity ward will be associated with target advertising for new parents. Particular videos may be sponsored by advertising organizations, or aspects of the user interface of the flat panel may include targeted advertising including banners, short audiovisual commercials and the like.

Advertising can be managed to reflect factors such as turnover whereby advertising fees will be based on number of beds in a particular ward and the ALOS for that particular ward, whereby the higher the patient turnover rate the higher the advertising fee.

Advertising can also be inserted on an FAQ sheet that accompanies the computer terminal 10.

In another particular aspect of the method of the present invention, an annuity is paid to operators (such as hospitals) based on the billable activities generated by means of the computer terminal 10.

Other variations and modifications of the invention are possible. For example, the present invention, with relatively minor modification, can be used in hotels and other situations where it is convenient for operators and customers to access different functions from the same computer terminal, and it is possible to subsidize the cost of such computer terminals by means of revenue generation activities of customers. The present invention can be adapted to apply to new forms of media and to interoperate with different operator systems. All such modifications or variations are believed to be within the sphere and scope of the invention as defined by the claims appended hereto. In addition these computers will be located on shelves with larger supermarket chains, treadmills, stationary workout centres in health club centres.

1. A point of care system comprising:
(a) At least one computer terminal;
(b) A server computer linked to the at least one computer terminal, the server computer including a server application, the server application being operable to provide on the server computer:
(i) An interface utility that is operable to link to one or more hospital systems, such hospital systems including one or more of a bed management system, a health record management system, and a clinical information systems;
(ii) A client service delivery facility, the client service delivery facility being operable to deliver services to the computer terminal, whether by operation of resources made available at the server computer or resources provided by other systems linked to the server computer, wherein the client service delivery facility is operable to manage the delivery of such services to the computer terminal;
Wherein the at least one computer terminal and the server computer are operable to co-operate to provide access at the at least one computer terminal:
(i) to the one or more hospital systems to authorized hospital personnel; and
(ii) to the services of the client service delivery facility to authorized hospital clients;
and wherein the at least one computer terminal is further operable to be used by authorized hospital personnel in conjunction with one or more medical devices, or as a medical device.

2. The point of care system claimed in claim 1, wherein the at least one computer terminal is medically certified.

3. The point of care system claimed in claim 1, wherein the technical specifications for the at least one computer terminal meets regulatory standards or best practices related to its use in conjunction with or as a medical device.

4. The point of care system claimed in claim 3, wherein the regulatory standards or best practices relate to one or more of:
(a) minimum interaction with electronic devices; and
(b) low leakage current power supply.

5. The point of care system claimed in claim 2, wherein the at least one computer terminal includes a touch screen.

6. The point of care system claimed in claim 5, wherein the at least computer terminal is linked to a client application, and wherein the client application includes:
(a) An access management facility that is operable to restrict access to the resources of the computer terminal to authorized users only, and to restrict access to specific resources of the computer terminal based on corresponding permissions defined for a particular authorized user; and
(b) A security facility that is operable to ensure that confidential or private data remains secure.

7. The point of care system claimed in claim 6, wherein the security facility is operable to prevent the computer terminal, or another device linked to the computer terminal, from making a copy of any confidential or private data accessed at the at least one computer terminal.

8. The point of care system claimed in claim 1, wherein the client service delivery facility includes a service management facility that is operable to manage access to services to clients, including sign-up of clients, management of client accounts, and client billing and payment.

9. The point of care system as claimed in claim 8, wherein the client service delivery facility provides access to one or more of the following resources:
(a) A food management system enabling patients to order their meals subject to any restrictions determined based on the patient's profile;
(b) Internet access;
(c) Voice-Over-IP telephone services; and/or (d) Entertainment services, including access to movies, music, television channels.

10. The point of care system as claimed in claim 6, wherein the access management facility interoperates with a card swipe to manage access to the resources of the at least one computer terminal based on permissions associated with the user of the card.

11. The point of care system as claimed in claim 6, wherein the client application further includes a billing management facility, or is linked to the server management facility for managing payment of the client for services provided by operation of the client service delivery facility.

12. The point of care system as claimed in claim 6, wherein the server application also includes a media delivery application, wherein the server computer is linked to a database, wherein the database stores a library of media content, or is linked to an external database including media content, and wherein the media delivery application is operable to provide access to such media content to the at least one computer terminal, as well as to audiovisual content obtained via the Internet or satellite feed.

13. The point of care system as claimed in claims 12, wherein the client application includes a media content delivery utility that enables authorized clients to view the media content provided to the at least one computer terminal by operation of the media delivery application.

14. A method of providing at hospitals a plurality of medically certified patient care terminals at a reduced cost to, or no cost to, the hospital, comprising the steps of:
(a) Providing a plurality of medically certified computer terminals, the medically certified computer terminals being operable to work in conjunction with one or more medical devices, or as medical devices;
(b) Linking the computer terminals to a server computer, the computer terminals and server computer being operable to provide access:
(i) To authorized hospital personnel, from the computer terminals to the following resources linked to the server computer: one or more hospital systems, such hospital systems including one or more of a bed management system, a health record management system, and a clinical information system, by operation of an interface facility linked to the server computer; and
(ii) To clients, for the computer terminals, by operation of a client application loaded on the computer terminal to: a client service delivery facility linked to the server computer, the client service delivery facility being operable to deliver services to the computer terminals, whether by operation of resources made available at the server computer or resources provided by other systems and linked to the server computer, the client service delivery facility being operable to provide access to services that include one or more of ordering meals by operation of a food management system, Internet access, telephone services, and entertainment services;
(c) The clients signing up for access to the resources of the client service delivery facility accessing services by operation of a service management facility; and
(d) The clients accessing services from the client service delivery facility for which they are billed by operation of a billing management facility.

15. The method of claim 14, comprising the further step of subsidizing the price of providing access to the bed side medically certified computer terminal based on the revenue generated by services consumed by clients by operation of the client service delivery facility.
